(19) United States
(12) Patent Application Publication
(10) Pub. No.: US 2025/0352967 A1
(43) Pub. Date: Nov. 20, 2025

(54) APPARATUS AND METHOD FOR SYNTHESIZING BORON NITRIDE NANOTUBES

(71) Applicant: NAIEEL TECHNOLOGY, INC., Daejeon (KR)

(72) Inventors: Jae Woo KIM, Daejeon (KR); Eun Kwang PARK, Daejeon (KR)

(73) Assignee: NAIEEL TECHNOLOGY, INC., Daejeon (KR)

(21) Appl. No.: 19/282,594

(22) Filed: Jul. 28, 2025

Related U.S. Application Data
(63) Continuation of application No. PCT/KR2024/019338, filed on Nov. 29, 2024.

(30) Foreign Application Priority Data
Nov. 30, 2023 (KR) 10-2023-0170816
Nov. 22, 2024 (KR) 10-2024-0168346

(51) Int. Cl. B01J 8/00; B01J 8/08; B01J 15/00; C01B 21/064

(52) U.S. Cl. CPC B01J 8/002; B01J 8/085; B01J 8/087; B01J 15/00; C01B 21/0641; B01J 2208/0053; B01J 2208/00752; C01P 2004/13

(57) ABSTRACT

An embodiment of the present invention discloses a boron nitride nanotubes synthesis apparatus including: a receiving unit that accommodates the precursor units, each comprising multiple precursors arranged in multiple rows; a reaction unit that receives the precursor units accommodated in the receiving unit and synthesizes nanomaterials using the precursors; and a supply unit connected to the receiving unit and the reaction unit, which receives the precursor units row by row from the receiving unit and supplies them to the reaction unit. The reaction unit includes the multiple tubular chambers that the precursors of the precursor units are simultaneously fed, and the reaction unit includes at least one heater and first, second, and third regions with different average temperatures, wherein the average temperature of the third region is higher than the average temperatures of the first and second regions.

### CROSS-REFERENCE TO RELATED APPLICATIONS

This application is a continuation of International Application No. PCT/KR2024/019338 filed on Nov. 29, 2024, which claims priority to Korean Patent Application No. 10-2023-0170816 filed on Nov. 30, 2023 and Korean Patent Application No. 10-2024-0168346 filed on Nov. 22, 2024, the entire contents of which are herein incorporated by reference.

### TECHNICAL FIELD

The present disclosure relates to the apparatus for synthesizing boron nitride nanotubes and synthesis method of boron nitride nanotubes using the same.

### BACKGROUND ART

Nanoscale materials have been significantly attracted in various industries, including the electronic industry, due to their excellent properties. However, their practical industrial applications have been challenged due to the lack of the mass production process of high-quality nanomaterials.

Among various nanoscale materials, boron nitride nanotubes (BNNT) exhibit similar mechanical property and thermal conductivity to the more commonly available carbon nanotubes (CNT). However, BNNT is superior in electrical insulation, heat resistance, and chemical stability. Furthermore, the boron consisting of BNNT has a thermal neutron absorption capability approximately 200,000 times higher than that of carbon in CNT, making it a useful material for neutron shielding.

Despite these advantages, mass production of BNNT is not currently easy due to difficulties in their synthesis process, such as high temperatures exceeding 1,000° C. for the synthesis. This situation is not only applied to BNNT; but other nanomaterials also require the development of the mass production technology of high quality nanomaterials.

### SUMMARY OF INVENTION

### Technical Problem

Embodiments of the present invention provide an apparatus capable of mass-producing, and efficiently synthesizing boron nitride nanotubes.

However, these aspects are exemplary and the tasks to be solved by the present disclosure are not limited thereto, and other unmentioned problems may be clearly understood by those skilled in the art from the description of the invention provided below.

### Solution to Problem

An embodiment of the present invention discloses a boron nitride nanotubes synthesis apparatus including: a storage unit housing the precursor units that each contains multiple precursors and form multiple rows; a reaction unit that receives the precursor units stored in the storage unit and synthesizes nanomaterials using the precursors; and a supply unit connected to the storage unit and the reaction unit, which receives the precursor units from the storage unit one row at a time and feeds them to the reaction unit. The reaction unit includes multiple tubular chambers that the precursors of the precursor units are simultaneously introduced. The reaction unit further includes at least one heater and a first region, a second region, and a third region with different average temperatures, wherein the average temperature of the third region is higher than the average temperatures of the first region and the second region.

### Advantageous Effects of Invention

According to embodiments of the present invention, large-scale synthesis of boron nitride nanotubes is possible, and the efficiency of the manufacturing process may be improved.

Furthermore, by directly injecting the reaction gas required for synthesis into the chambers, the manufacturing yields may be improved.

However, the achievable effects through the present invention are not limited to the above-mentioned effects, and other unmentioned technical effects will be clearly understood by those skilled in the art from the description of the invention provided below.

### BRIEF DESCRIPTION OF DRAWINGS

The following drawings attached to this specification illustrate preferred embodiments of the present invention and serve to further enhance the understanding of the technical concept of the present invention in conjunction with the detailed description of the invention provided below. Therefore, the present invention should not be construed as being limited only to the matters described in such drawings.

FIG. 1 is a schematic diagram illustrating an example of an apparatus for the boron nitride nanotubes synthesis according to an embodiment of the present invention.

FIG. 2 is a schematic flowchart illustrating a method for synthesizing boron nitride nanotubes according to an embodiment of the invention.

FIG. 3 is a schematic perspective view illustrating an example of a precursor for the nanomaterial synthesis according to an embodiment of the present invention.

FIG. 4 is a schematic cross-sectional view illustrating an example of the A-A′ cross-section of FIG. 3.

FIG. 5 is a schematic planar view illustrating an example of the supply unit and reaction unit of the boron nitride nanotubes synthesis apparatus of FIG. 1.

FIG. 6 is a schematic planar view illustrating an example of the storage unit of the boron nitride nanotubes synthesis apparatus of FIG. 1.

FIG. 7 is a schematic planar view illustrating an example of the pusher of the supply unit of the boron nitride nanotubes synthesis apparatus of FIG. 1.

FIG. 8 is a schematic planar view illustrating an example of the reaction unit of the boron nitride nanotubes synthesis apparatus of FIG. 1.

FIG. 9 is a schematic perspective view illustrating an example of the chamber and tubing of the reaction unit of FIG. 8.

FIG. 10 is a schematic perspective view illustrating another example of the chamber and tubing of the reaction unit of FIG. 8.

FIG. 11 is a schematic perspective view illustrating yet another example of the chamber and tubing of the reaction unit of FIG. 8.

FIG. 12 is a schematic perspective view illustrating still another example of the chamber and tubing of the reaction unit of FIG. 8.

### DETAILED DESCRIPTION OF THE INVENTION

An embodiment of the present invention discloses a boron nitride nanotubes synthesis apparatus including: a storage unit housing the precursor units that each contains multiple precursors and form multiple rows; a reaction unit that receives the precursor units stored in the storage unit and synthesizes nanomaterials using the precursors; and a supply unit connected to the storage unit and the reaction unit, which receives the precursor units from the storage unit one row at a time and feeds them to the reaction unit. The reaction unit includes multiple tubular chambers that the precursors of the precursor units are simultaneously introduced. The reaction unit further includes at least one heater and a first region, a second region, and a third region with different average temperatures, wherein the average temperature of the third region is higher than

In some embodiment, the precursor may be a precursor for synthesizing boron nitride nanotubes.

In some embodiment, the supply unit may include at least one pusher that introduces the precursor units into the reaction unit.

In some embodiment, the pusher may simultaneously push the precursors of the precursor units in a single row.

In some embodiment, the storage unit may be movable up and down.

In some embodiment, the outer surface of the storage unit may include a guide part for guiding the movement of the storage unit.

In some embodiment, each of the chambers may be connected to two or more tubes for supplying reaction gas.

In some embodiment, the reaction unit may further include a fourth region and a fifth region with average temperatures lower than that of the third region and different from each other.

Another embodiment of the present invention discloses a method for synthesizing boron nitride nanotubes, comprising: a step of transferring precursor units, each containing multiple precursors and forming multiple rows, to a supply unit; a step of simultaneously introducing the precursors of the precursor units in one row into a reaction unit by a pusher; a step of synthesizing a nanomaterial by reacting the precursor units and the reaction gas introduced into the reaction unit; and a step of discharging the synthesized nanomaterial from the reaction unit to a discharge unit; wherein the reaction unit includes multiple tubular chambers than the precursors of the precursor units are simultaneously introduced, and the reaction unit includes at least one heater and a first region, a second region, and a third region with different average temperatures, and the average temperature of the third region is higher than the average temperature of the second region.

In some embodiment, the temperature changes over time in the reaction unit may be 4° C. to 9° C.

In some embodiment, each of the chambers may be connected to two or more tubes for supplying reaction gas.

In some embodiment, in the step of transferring to the supply unit, the storage unit may move towards the supply unit to transfer the precursor units to the supply unit.

In some embodiment, once all the precursor units stored in the storage unit are supplied to the supply unit, the storage unit may move to the opposite direction of the supply unit.

In some embodiment, the nanomaterials may be synthesized in the third region.

In some embodiment, the reaction unit may further include a fourth region and a fifth region with average temperatures lower than that of the third region and different from each other.

### MODE FOR THE INVENTION

Hereinafter, preferred embodiments of the present invention will be described in detail with reference to the accompanying drawings. Before proceeding, it should be noted that the terms and words used in this specification and claims should not be construed as being limited to their ordinary or dictionary meanings. Rather, based on the principle that an inventor can appropriately define the concept of terms to best describe their own invention, they should be interpreted with meanings and concepts consistent with the technical spirit of the present invention. Therefore, the embodiments described, and the configurations shown in the drawings in this specification are merely some of the most preferred embodiments of the present invention and do not represent the entire technical scope of the present invention. It should be understood that various equivalents and modifications capable of replacing them may exist at the time of this application.

Furthermore, as used herein, “comprise,” “include,” and/or “comprising,” “including” specify the presence of stated shapes, numbers, steps, operations, members, elements, and/or groups thereof, and do not exclude the presence or addition of one or more other shapes, numbers, operations, members, elements, and/or groups.

Also, for ease of understanding of the invention, the attached drawings are not necessarily drawn to actual scale, and the dimensions of some components may be exaggerated. Additionally, the same reference numerals may be assigned to the same components in different embodiments.

Although terms such as “first,” “second,” etc., may be used to describe various components, these components are not limited by these terms. These terms are used only to distinguish one component from another, and unless otherwise specified, a first component may also be a second component.

Throughout the specification, unless otherwise specified, each component may be singular or plural.

The placement of any component “above (or below)” another component, or “on (or under)” another component, means not only that the component is placed in contact with the upper (or lower) surface of the component, but also that other components may be interposed between the component and any component placed on (or under) it.

Furthermore, when a component is described as “connected,” “coupled,” or “joined” to another component, it should be understood that the components may be directly connected or joined to each other, or other components may be “interposed” between the components, or each component may be “connected,” “coupled,” or “joined” through other components. Also, when a part is said to be “electrically coupled” to another part, it includes not only cases where they are directly connected but also cases where they are connected to other elements interposed between them.

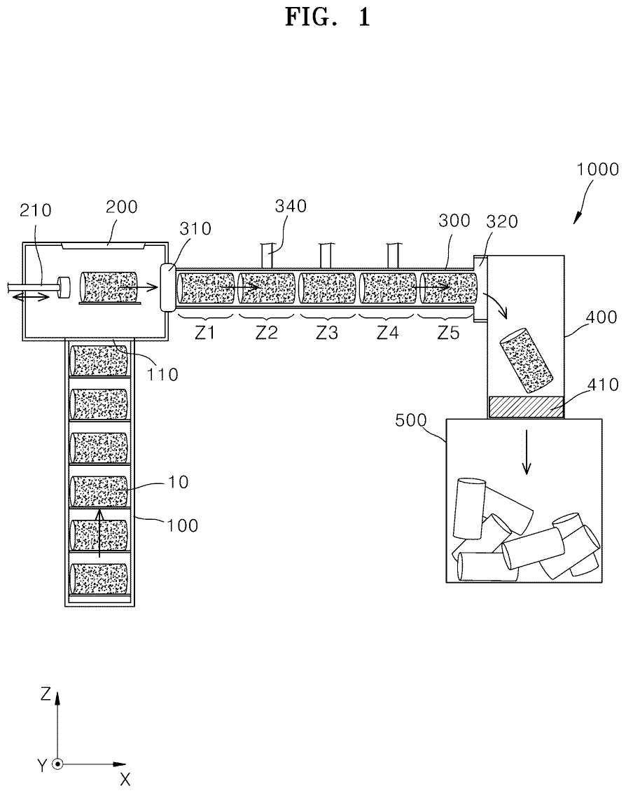

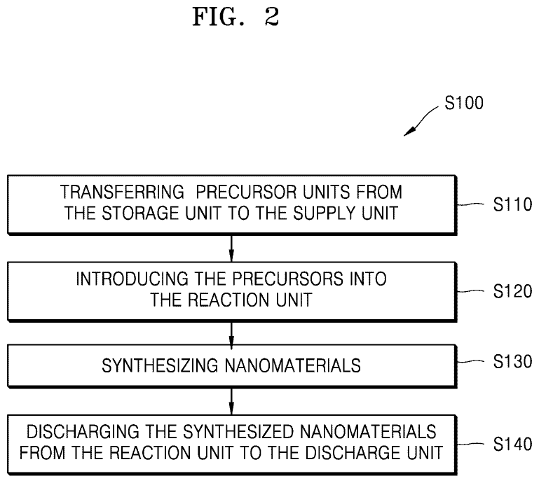

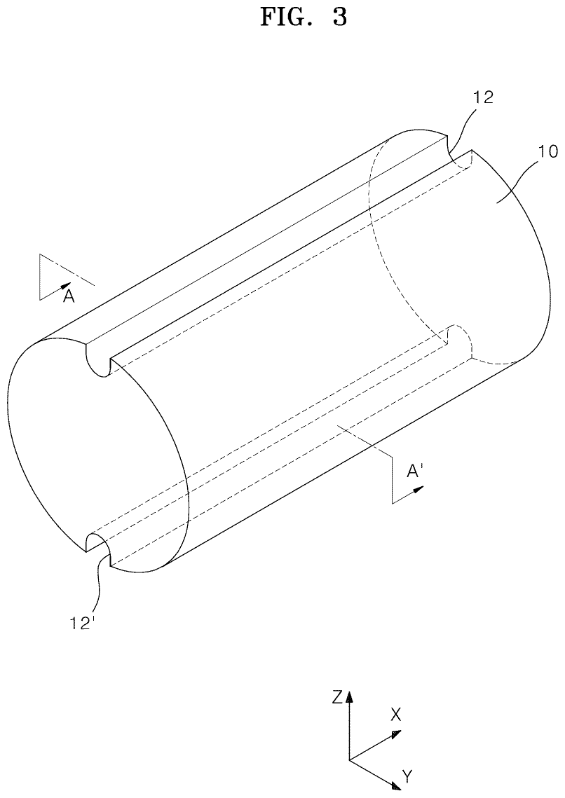

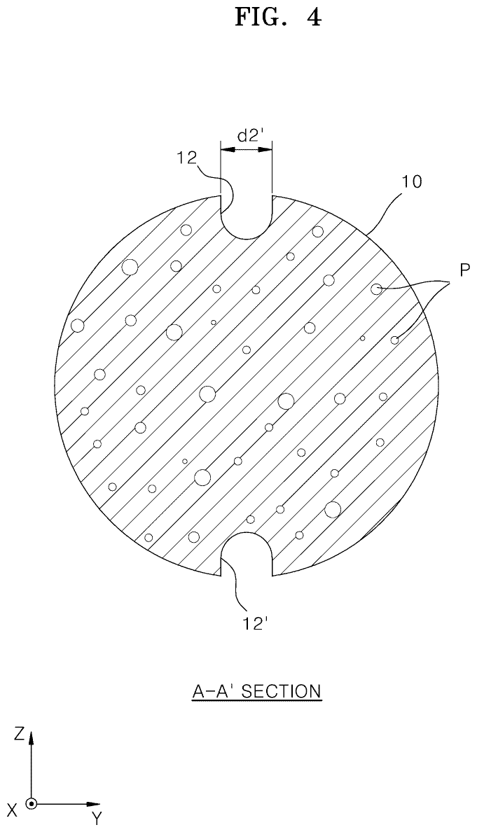

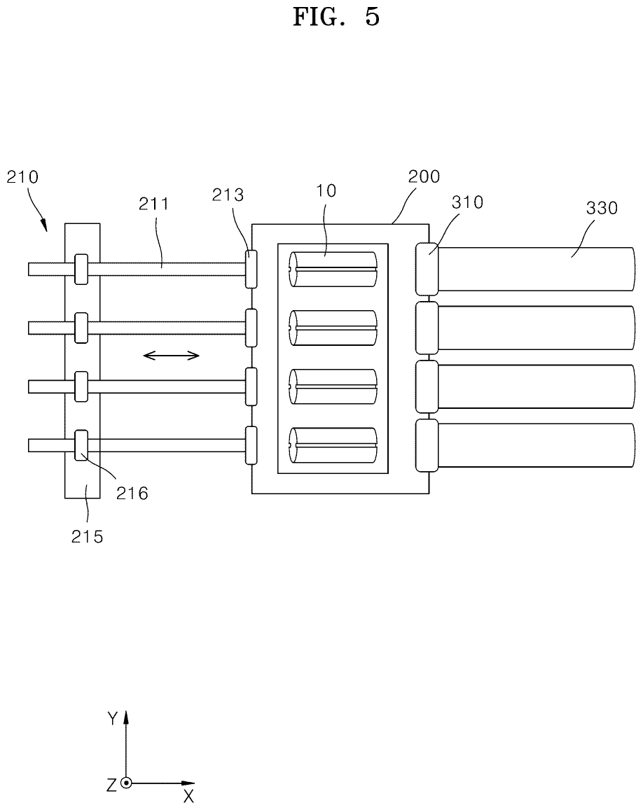

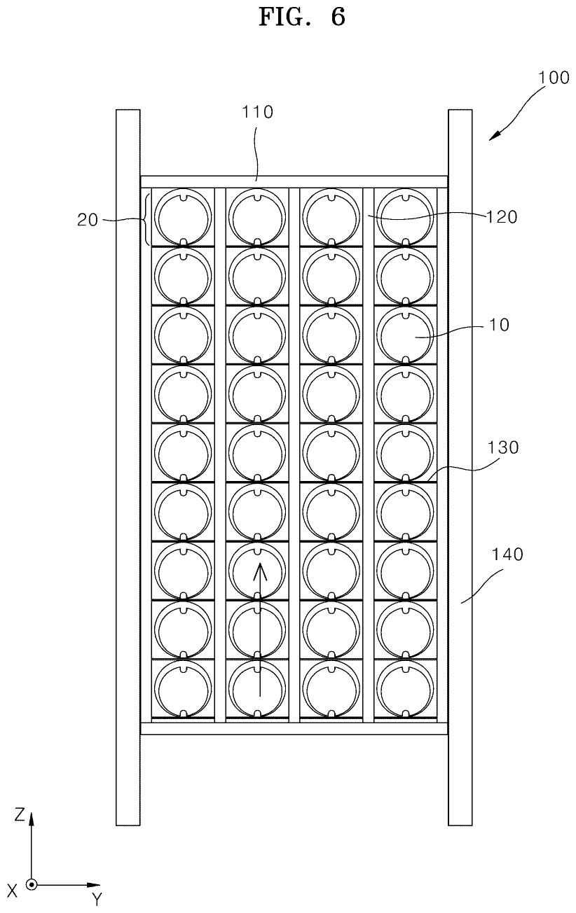

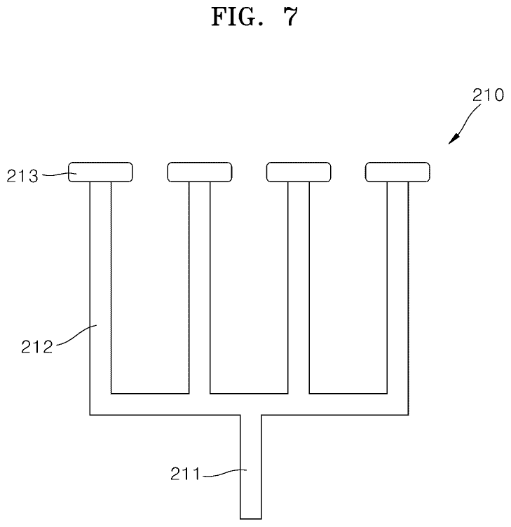

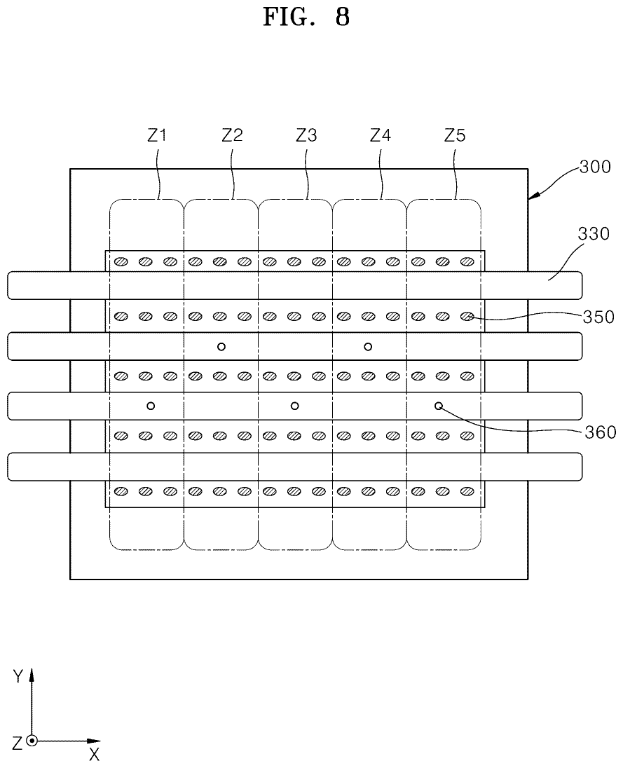

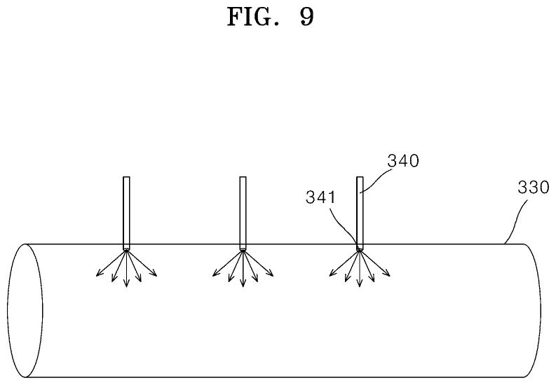

FIG. 1 is a schematic diagram illustrating an example of an apparatus for synthesizing boron nitride nanotubes according to an embodiment of the present invention. FIG. 2 is a flowchart schematically illustrating a method for synthesizing boron nitride nanotubes according to an embodiment of the present invention. FIG. 3 is a perspective view schematically illustrating an example of a nanomaterials synthesis precursor according to an embodiment of the present invention. FIG. 4 is a cross-sectional view schematically illustrating an example of the A-A′ cross-section of FIG. 3. FIG. 5 is a planar view schematically illustrating an example of the supply unit and reaction unit of the boron nitride nanotubes synthesis apparatus of FIG. 1. FIG. 6 is a planar view schematically illustrating an example of the storage unit of the boron nitride nanotubes synthesis apparatus of FIG. 1. FIG. 7 is a planar view schematically illustrating an example of the pusher of the supply unit of the boron nitride nanotubes synthesis apparatus of FIG. 1. FIG. 8 is a planar view schematically illustrating an example of the reaction unit of the boron nitride nanotubes synthesis apparatus of FIG. 1. And FIG. 9 is a perspective view schematically illustrating an example of the chamber and tubing of the reaction unit of FIG. 8.

Referring to FIGS. 1 to 9, a boron nitride nanotubes (BNNT) synthesis apparatus 1000 according to an embodiment of the present invention may include: a storage unit 100 configured to accommodate precursor units 20, each containing multiple precursors 10 arranged in multiple rows; a reaction unit 300 configured to receive the precursor units 20 stored in the storage unit 100 and synthesize nanomaterials using the precursor units 20; a supply unit 200 connected to the storage unit 100 and the reaction unit 300, configured to receive the precursor units 20 from the storage unit 100 one row at a time and feed them to the reaction unit 300; a discharge unit 400 from which the nanomaterials synthesized in the reaction unit 300 are discharged; and a storage unit 500 connected to the discharge unit 400 and configured to store the synthesized nanomaterials.

Furthermore, a method for synthesizing boron nitride nanotubes S100 according to an embodiment of the present invention may include the steps of: transferring S110 precursor units 20, each containing the multiple precursors 10 arranged in multiple rows, from the storage unit 100 to the supply unit 200; simultaneously introducing S120 the precursors 10 of a single row of precursor units 20 into the reaction unit 300 by a pusher 210; synthesizing nanomaterials S130 by reacting the precursor units 20 with reaction gas introduced into the reaction unit 300; and discharging S140 the synthesized nanomaterials from the reaction unit 300 to the discharge unit 400.

Referring to FIG. 3, a precursor 10 for nanomaterial synthesis according to an embodiment of the present invention may include at least one accepting region along the longitudinal direction X of the precursor 10. The accepting regions may, for example, include guiding grooves 12, 12′. However, it is not limited thereto; the accepting regions may also include at least one flat surface on the top and bottom surfaces of the precursor 10 so that the precursors 10 may be stacked one by one. The accepting surfaces may be formed as a continuously flat surface along the longitudinal direction of the precursor 10.

As another example, the accepting region may include the multiple through-holes that penetrate from the outside towards the inside of the precursor 10. The multiple through-holes may be formed radially with respect to an imaginary line passing through the central axis of the precursor 10, and the multiple through-holes may be provided spaced apart from each other along the longitudinal direction of the precursor 10. For instance, the guiding grooves 12, 12′ may be connected with at least one of the multiple through-holes.

The guiding grooves 12, 12′ are continuous along the longitudinal direction X of the precursor 10 and may be formed in a direction from the outside (or outer circumferential surface) towards the inside of the precursor. Additionally, the guiding grooves 12, 12′ may, for example, be symmetrically provided on the top and bottom surfaces of the precursor 10 with respect to a plane passing through the central axis of the precursor 10.

The precursor 10 may, for example, be a precursor for boron nitride nanotubes (BNNT) synthesis. Boron nitride nanotubes are hexagonal nanotubes with alternating nitrogen (N) and boron (B) atoms, possessing an excellent thermal conductivity while having a wide bandgap, thus exhibiting electrical insulation properties similar to ceramics. Therefore, boron nitride nanotubes may be applied as electrically insulating but highly thermally conductive composites.

Moreover, boron nitride nanotubes are known for their excellent mechanical properties, chemical resistance, and oxidation resistance, their ability to absorb thermal neutrons, and their harmlessness to the human body, making them applicable in various industrial fields such as electronics, energy, aerospace, nuclear engineering, and biomedical.

Meanwhile, the precursor 10 may be cylindrical shaped. Here, “cylindrical shape” includes not only the basic cylindrical shape but also shapes derived and modified from it. As the precursor 10 has a cylindrical shape, it may be easily introduced into the chamber of the boron nitride nanotubes synthesis apparatus 1000, which will be described later, and may be easily accommodated in the storage unit 100. This offers the advantage of improving the efficiency of the nanomaterial synthesis, and reducing the process difficulty in the boron nitride nanotube synthesis apparatus 1000.

The method for preparing the precursors 10 may include the steps of: preparing a first powder including a raw material and a catalyst; obtaining a second powder by nano-sizing the first powder; preparing a dispersion solution including the second powder; molding the dispersion solution to obtain a columnar precursor 10; and creating micropores P in the precursor 10 to obtain the porous precursors 10 for the nanomaterial synthesis.

The raw material may, for example, be powdered boron. Specifically, the boron may be amorphous and/or crystalline boron. Because amorphous boron has low hardness, it effectively contributes to the nano-sizing of the catalyst metals and/or metal oxide particles additionally mixed during the nano-sizing step, specifically during the nano-sizing process of boron powder using an air vortex. Furthermore, boron powder may be coated or embedded on the surface of catalyst metal and/or metal oxide, synthesizing the seed precursor nanoparticles efficiently.

The catalyst may be provided in the powder form. The catalyst may be more effective for combination with amorphous boron. This is because, when using amorphous boron, a large amount of boron precursor powder may be produced within a very short time during the nano-sizing process by air jets and/or their vortex. The catalyst is not particularly limited and may include, for example, Fe, Mg, Ni, Cr, Co, Zr, Mo, W, and/or Ti, and their oxides, among others.

The catalyst, during the nano-sizing process of the raw materials, mixes with the raw materials to form the precursor nanoparticles. These precursor nanoparticles act as seeds during precursor production and may contribute to the nanomaterial synthesis by reacting with gas. For example, boron precursor nanoparticles may react with nitrogen for the synthesis of boron nitride nanotubes.

The method of nano-sizing the first powder may be formed by introducing the first powder into a grinding region created by air. For example, the first powder may be nano-sized through air jet milling. In this process, the air jet milling conditions may include a feed rate of 2 g/min to 10 g/min, a feed pressure of 80 psi to 120 psi, and a grinding pressure of 60 psi to 100 psi. Through the air jet milling process under these conditions, the first powder may be effectively nano-sized. This allows the catalyst to be embedded in the boron particles, which may then act as a key factor in the subsequent nanotube growth.

The dispersion solution may include the second powder, binder powder, and foaming agent. In this case, the weight ratio of the second powder, binder powder, and foaming agent may be 1:1 to 4:0.1 to 0.2. Any binder powder and foaming agent known in the art may be used without limitation.

The step of molding the dispersion solution containing the second powder to obtain a columnar precursor 10 for the nanomaterial synthesis may include injecting the dispersion solution into a columnar mold and heating the mold. The heating temperature of the mold may be 150° C. to 250° C. and the heating time may be 0.5 hours to 8 hours.

By heat-treating the mold under the aforementioned temperature and time conditions, a columnar precursor for the nanomaterials synthesis may be readily obtained. At this time, the step of molding a columnar precursors for the nanomaterials synthesis and the step of obtaining a porous precursor for the nanomaterials synthesis may be performed simultaneously. For example, a precursor 10 for the nanomaterial synthesis having a columnar shape, and a porous structure may be obtained through a process of placing the dispersion solution in a cylindrical mold and heat-treating it.

Meanwhile, the precursor 10 for the nanomaterials synthesis has a lower heat capacity compared to a reaction module (made of ceramics that may hold the precursors), allowing for rapid introduction into the chamber 330 of the boron nitride nanotubes synthesis apparatus 1000, which will be described later, thereby effectively improving the efficiency of the boron nitride nanotubes synthesis process.

Additionally, the precursor 10 nanomaterials synthesis may be directly introduced into the chamber 330 without a reaction module, which facilitates maintenance and may reduce the production cost of boron nitride nanotubes synthesis. Furthermore, because the precursor 10 nanomaterials synthesis is light, the possibility of damage to the boron nitride nanotubes synthesis apparatus 1000, since the thermal shock on its components is low, which may improve the stability of the nanomaterials synthesis system.

Meanwhile, the storage unit 100 and the supply unit 200 of the boron nitride nanotubes synthesis apparatus 1000 may be provided with the jointing parts corresponding to the storage grooves 12, 12′. Accordingly, the precursor 10 may be stably stored in the storage unit 100, which may make the stacking and storage of the precursor 10 more reliable.

Moreover, the precursor 10 introduced from the storage unit 100 to the supply unit 200 may be arranged to align with the position of the pusher, which will be described later, allowing the boron nitride nanotubes synthesis apparatus 1000 to be automated, and the precursor 10 may be easily introduced from the supply unit 200 to the reaction unit 300.

In the chamber of the reaction unit 300 where the precursor 10 moves and nanomaterials are synthesized, a jointing part or guiding part corresponding to the guiding grooves 12, 12′ may be arranged. As a result, the precursor 10 may move within the chamber 330 without falling apart.

The precursors may be mounted on a separate reaction module to be introduced into the reaction unit, if the conventional precursors don't have a guiding region, lowing the synthesis process efficiency. In contrast, the precursor 10 according to an embodiment of the present invention has an guiding region formed directly on it, allowing for direct introduction into the boron nitride nanotubes synthesis apparatus 1000 without a separate reaction module, thereby effectively improving the process efficiency and enabling mass production of nanomaterials.

Referring to FIG. 4, the ratio of the diameter of the precursor 10 to the diameter d2′ of the guiding grooves 12, 12′ may be 1:0.0001 to 1:0.3. When the ratio of the diameter of the precursor 10 to the diameter d2′ of the guiding grooves 12, 12′ is within the aforementioned range, the precursor 10 may be stably accommodated in the storage unit 100 through the guiding grooves 12, 12′, and the mechanical properties such as strength and durability of the precursors 10 may be effectively maintained.

Furthermore, the ratio of the diameter of the precursor 10 to the length of the precursor 10 may be 1:3 to 1:6. When the ratio of the diameter to the length of the precursor 10 is within the aforementioned range, reaction gas may be effectively supplied to the precursor 10 moving in the reaction chamber 330 of the boron nitride nanotubes synthesis apparatus 1000, further increasing the synthesis efficiency of nanomaterials. Also, by adjusting the ratio of the diameter to the length of the precursor 10 to the aforementioned range, the precursor 10 may be effectively accommodated in the storage unit 100 and easily introduced into the chamber 330.

Meanwhile, the diameter d2′ of the guiding grooves 12, 12′ may present the shortest length among the lengths passing through the central axis of the guiding grooves 12, 12′, and the diameter of the precursor 10 may present the longest length among the lengths passing through the central axis in the cross-section of the precursor (e.g., a cylinder). Also, the diameter of the precursor may be varied to match the diameter of the chamber of the boron nitride nanotubes synthesis apparatus 1000 described later.

Meanwhile, the precursor 10 may have a porous structure. For example, the precursor 10 may have a porous structure including the multiple micropores P. In this case, for convenience of explanation, the micropores P are shown magnified in FIG. 4. Although FIG. 4 discloses that the multiple micropores P are included inside the precursor 10, the multiple micropores P may also be formed on the outer surface of the precursor 10. When the precursor 10 has a porous structure, the contact area with the reaction gas, which will be described later, may be further increased, leading to further enhance the nanomaterial synthesis efficiency.

Referring to FIG. 6 in conjunction with FIG. 1, the storage unit 100 may include a storage gate 110 connected to the supply unit 200 and capable of opening and closing, partitions 120 that partition the precursors 10 along the height direction Z of the storage unit, placement parts 130 where the precursors 10 are respectively placed, and guide parts 140 that guide the movement of the storage unit 100.

The precursors 10 may be stored in the space partitioned by the partitions 120 and the placement parts 130. Accordingly, the precursor 10 may be isolated from other adjacent precursors 10. As a result, the precursor 10 may be independently introduced into the chamber, which will be described later.

The placement parts 130 may be provided with jointing parts corresponding to the accommodation grooves 12, 12′ formed in the precursor 10. Accordingly, the precursor 10 may be stably accommodated in the storage unit 100, making stacking and storage of the precursor 10 reliable.

Although FIG. 6 illustrates that the placement parts 130 are provided with jointing parts corresponding to the guiding grooves 12, 12′ formed in the precursor 10, it is not limited thereto. As another example, the storage unit 100 may include a separate jig corresponding to the shape of the precursor 10, and the precursors 10 may each be accommodated in the jig.

As yet another example, as described above, if the guiding region includes an accommodation surface, the placement parts 130 may be omitted, and the precursors 10 may be stacked one by one along the flat accommodation surface.

Meanwhile, each row of the storage unit 100 may accommodate precursor units 20, each containing the multiple precursors 10 and forming multiple rows. A precursor unit 20 may include at least one precursor 10. For example, a precursor unit 20 may include four precursors 10 as shown in FIG. 6, but it is not limited thereto, and the number of precursors 10 included in a precursor unit 20 may be changed as needed.

The storage gate 110 connecting the storage unit 100 and the supply unit 200 may be opened and closed. As the storage gate 110 opens, the precursor units 20 stored in each row of the storage unit 100 may be transferred to the supply unit 200. At this time, the storage gate 110 may be opened to supply the precursor units 20 from the storage unit 100 to the supply unit 200 one by one.

In the step of transferring S110 the multiple precursor units 20 from the storage unit 100 to the supply unit 200, when the storage gate 110 opens, the storage unit 100 may move to the direction Z of the supply unit 200 to supply the precursor units 20 to the supply unit 200 one row at a time. That is, the precursor units 20 may be supplied from the storage unit 100 to the supply unit 200 in a bullet-feed manner.

When all precursor units 20 stored in the storage unit 100 are supplied to the supply unit 200, the storage unit 100 may move back to the opposite direction −Z to its original position. Once the storage unit 100 is restored, new precursor units 20 may be stored in the storage unit 100, and the above process may be repeated.

As presented in an embodiment of the present invention, by continuously supplying precursor units 20, each containing at least one precursor 10, from the storage unit 100 to the supply unit 200, mass production of nanomaterials is possible, and the efficiency of the manufacturing process may be increased.

Meanwhile, the guide part 140 may guide the movement of the storage unit 100 when the storage unit 100 moves up and down. For example, the guide part 140 may include a guide groove, and the storage unit may include a protrusion corresponding to the guide groove. Conversely, the guide part 140 may include a protrusion, and the storage unit 100 may include a corresponding guide groove.

Referring to FIG. 5 in conjunction with FIG. 1, the supply unit 200 may be located at the front of the reaction unit 300. The supply unit 200 may accommodate one or more precursor units 20. While FIG. 1 shows the supply unit 200 accommodating a single precursor unit 20, it is not limited thereto, and the multiple precursor units 20 may be accommodated in the supply unit 200. The supply unit 200 may further include at least one pusher 210 that feeds the precursor units 20 received from the storage unit 100 into the reaction unit 300, a mount 215 for mounting the at least one pusher 210, and a fixing part 216 that prevents the pushers 210 falling apart from the mount 215 in the case when at least one pusher 210 moves. A lubricant may be applied to the fixing part 216 to facilitate the movement of the pushers 210.

In the step of introducing S120 the precursor units 20 to the reaction unit 300, the at least one pusher 210 may move to one direction X, −X to continuously feed the precursors 10 one by one into the multiple chambers 330 of the reaction unit 300. That is, the precursors 10 of a single row of precursor units 20 may be simultaneously introduced into the reaction unit 300 by the pusher 210.

The pusher 210 may include a main part 211 and a pushing part 213 provided at one end of the main part 211. The pushing part 213 may push the precursor 10 to feed the precursor 10 into the chamber 330.

The pusher 210 may further include a buffering member at the part where the pushing part 213 and the precursor 10 come into contact. Accordingly, during introducing the precursors 10 into the chamber 330, damage or deformation of the precursors 10 may be effectively prevented. The buffering member may, for example, include a sponge, but is not limited thereto.

Meanwhile, the pusher 210 may be arranged to face the inlet 310 of the chamber 330, and the pusher 210 may feed the precursors 10 into the chamber 330 in a bullet-feed manner. By individually feeding the precursors 10 into the multiple chambers 330 in a bullet-feed manner using the pusher 210, the supply unit 200 may feed the precursors 10 into the multiple chambers 330 faster compared to conventional methods which use a reaction module to introduce precursors, enabling mass production of boron nitride nanotubes and improving the process efficiency.

Meanwhile, the inlet 310 of the chamber 330 may include a gate. By providing a gate between the chamber 330 and the supply unit 200, the temperature and gas atmosphere (e.g., nitrogen atmosphere) inside the chamber 330 may be optimized before supplying the precursors 10 from the supply unit 200 into the chamber 330.

A vacuum pump may be installed in the supply unit 200 so that the gate between the supply unit 200 and the chamber 330 is opened, the reaction gas atmosphere and pressure of the supply unit 200 and the chamber 330 may be controlled. This allows the precursors 10 to be transferred from the supply unit 200 to the chamber 330 via the pusher 210, and the gate may be closed after transfer.

Meanwhile, as shown in FIG. 5, the pusher 210 may have multiple pushers 210 for each chamber 330 to simultaneously push each precursor 10 into the multiple chambers 330 arranged side by side. This allows the precursors 10 of a single row of precursor units 20 to be simultaneously introduced into each chamber 330 of the reaction unit 300. That is, the pusher 210 may simultaneously push the precursors 10 of one row of precursor units 20 into the reaction unit 300.

As another example, as shown in FIG. 7, the pusher 210 may include a fork shape. For example, the pusher 210 may include a main part 211, the multiple sub-parts 212 branched from the main part 211, and pushing parts 213 provided at one end of each of the sub-parts 212.

When the pusher 210 includes a fork shape, without the need to operate multiple pushers 210, only the main part 211 of the fork-shaped pusher 210 may be operated to simultaneously introduce the multiple precursors 10 into the multiple chambers 330.

Meanwhile, the supply unit 200 may include various types of lifts to continuously supply the multiple precursors 10 to the multiple chambers 330. For example, if the supply unit 200 accommodates the multiple precursors 10 in a vertical configuration, the lift may move in the vertical direction Z to locate the precursors 10 in front of at least one pusher 210 of the supply unit 200.

Additionally, if the supply unit 200 accommodates the multiple precursors 10 in a horizontal configuration, the lift may move horizontally to locate the precursors 10 in front of at least one pusher 210 of the supply unit 200. Also, if the precursors 10 are accommodated on a circulating orbit in the supply unit 200 like a windmill, the lift may move circularly to locate the precursors 10 in front of at least one pusher 210 of the supply unit 200.

Accordingly, the supply unit 200 may continuously supply the precursors 10 to the chambers 330 in a single line. For example, the pusher 210 may feed a first precursor 10 into the chamber 330, and after positioning a second precursor 10 in front of the pusher 210, the pusher 210 may feed the second precursor 10 into the chamber 330. This allows the boron nitride nanotubes synthesis apparatus 1000 to stably and quickly feed the precursors 10 into the chambers 330, enabling mass production of nanomaterials efficiently.

Referring to FIGS. 8 and 9 in conjunction with FIG. 1, the reaction unit 300 may include: the multiple tubular chambers 330 arranged side by side, through which the precursor units 20 move and react to synthesize nanomaterials; the multiple heaters 350 spaced apart from and positioned on both sides of each chamber 330; and a temperature sensor 360 located in at least one chamber 330.

The multiple chambers 330 may be arranged in parallel. Therefore, mass production of nanomaterials is possible, and the efficiency of the manufacturing process may be improved.

The chamber 330 may, for example, have a cylindrical shape and may receive the precursors 10 supplied from the supply unit 200. Thereafter, the chambers 330 may synthesize nanomaterials (e.g., BNNTs) using the precursors 10 in the second to fourth regions, which will be described later.

Additionally, the chamber 330 may be provided with a joint part or guide part corresponding to the guiding grooves 12, 12′. As a result, the precursors 10 may move within the chamber 330 without falling apart.

Meanwhile, in the step of synthesizing S130 nanomaterials (e.g., boron nitride nanotubes) by reacting the precursor units 20 with the reaction gas introduced into the reaction unit 300, the precursors 10 need the thermal energy to react with the reaction gas in the reaction unit 300, which will be described later, to synthesize nanomaterials.

The multiple heaters 350 may supply thermal energy to the chambers 330 when the precursors 10 pass through, while the reaction gas is supplied. At this time, the multiple heaters 350 may supply heat to the multiple chambers 330 spaced apart from each other on both sides of each chamber 330 along the longitudinal direction of the chambers 330. Additionally, each of the multiple heaters 350 may be connected to a controller that controls the temperature of the multiple heaters 350.

The rate of the temperature changes over time in each of the chambers 330 of the reaction unit 300 may be from 4° C. to 9° C. If the rate of temperature changes over time in each chamber 330 is less than 4° C., the nanomaterial synthesis reaction needs to be performed for a long time. Also, if the rate of temperature change over time in each chamber 330 exceeds 9° C., the temperature of the chambers 330 of the reaction unit 300 fluctuates, and thus there is a risk that the synthesis efficiency of boron nitride nanotubes decreases and may damage the reaction chambers 330 by thermal shock.

The heat treatment for the nanomaterials synthesis within the chamber 330 of the reaction unit 300 may be performed at a temperature range of 1100° C. to 1700° C. for 0.5 to 6 hours. The chambers 330 of the reaction unit 300 may, for example, use an alumina tube, but is not necessarily limited thereto, and may be formed from a heat-resistant material capable of withstanding the temperatures up to approximately 1700° C.

Meanwhile, the reaction unit 300 may include a first region Z1, a second region Z2, and a third region Z3 with different average temperatures. At this time, the average temperature of the third region Z3 may be higher than the average temperature of the second region Z2, and the average temperature of the second region Z2 may be higher than the average temperature of the first region Z1.

Additionally, the reaction unit 300 may further include a fourth region Z4 and a fifth region Z5 with different average temperatures, both are lower than the average temperature of the third region Z3. Specifically, the average temperature of the third region Z3 may be higher than the average temperature of the fourth region Z4, and the average temperature of the fourth region Z4 may be higher than the average temperature of the fifth region Z5.

That is, the temperature of the reaction unit 300 may sequentially increase from the first region Z1 located near the inlet 310 connected to the supply unit, up to the third region Z3, and then sequentially decrease again to the fifth region Z5. Through this, the temperature of the precursor 10 does not change abruptly but gradually increases while passing through the first region Z1 to the fifth region Z5, and then gradually decreases again. As a result, damage to the precursor 10 due to thermal shock may be prevented, and the synthesis efficiency of the boron nitride nanotube synthesis apparatus 1000 may be improved.

Specifically, the average temperature of the first region Z1 may be 1000° C. to 1300° C., the average temperature of the second region Z2 may be from 1100° C. to 1400° C., the average temperature of the third region Z3 may be from 1200° C. to 1700° C., the average temperature of the fourth region Z4 may be from 1200° C. to 1500° C., and the average temperature of the fifth region Z5 may be 1150° C. to 1400° C.

Meanwhile, the reaction where precursors 10 react with reaction gas to synthesize nanomaterials may primarily occur in the third region Z3, which has the highest temperature. However, it is not limited thereto, and the nanomaterial synthesis reaction may also occur in the second region Z2 or fourth region Z4, which are close to the third region Z3 and have sufficiently high temperatures.

The reaction unit 300 may include a temperature sensor 360 located in at least one chamber 330. Accordingly, the temperature sensor 360 may precisely measure the temperature of each region, allowing the multiple heaters 350 to supply thermal energy corresponding to the temperature range of each region to the first to fifth regions, thereby controlling the temperature of the reaction unit 300. However, the placement of the temperature sensor 360 is not limited thereto, and any placement is possible as long as it may measure the temperature of each region of the reaction unit 300.

Meanwhile, each of the chambers 330 may be connected to two or more tubes 340 that supply reaction gas. The tubes 340 may directly supply reaction gas into the chamber 330 at a point between both ends of the chamber 330. Accordingly, the consumption rate of reaction gas may be reduced, and the synthesis efficiency of nanomaterials may be improved.

The tubes 340, each including the gas injection ports 341 from which reaction gas is injected, may be arranged spaced apart from each other along the longitudinal direction of the chamber 330 as shown in FIG. 9. Additionally, each of the tubes 340 may vertically penetrate the chamber 330 from the top of the chamber 330 and extend into the chamber 330. Accordingly, each of the tubes 340 may directly inject reaction gas into the chamber 330.

As such, by arranging the multiple tubes 340 and directly injecting reaction gas into the chamber 330, the concentration of reaction gas reacting with the precursors 10 within the chamber 330 may be kept uniform, thereby improving the synthesis efficiency of nanomaterials.

The reaction gas may, for example, be a nitrogen-containing gas, and nanomaterials may be synthesized inside and on the surface of the precursors 10 by the reaction between the precursors 10 and the reaction gas. For example, boron nitride nanotubes may be synthesized and grown inside and on the surface of the precursors 10. The reaction gas may, of course, use nitrogen (N2) and/or ammonia (NH3), or these may be mixed and supplied as a mixed gas. Alternatively, hydrogen (H2) may be additionally mixed and used.

At this time, the reaction gas may be supplied to the chamber 330 at a rate of 10 sccm to 1000 sccm. If the reaction gas is supplied at a rate less than 10 sccm, the supply of nitrogen source for the reaction is insufficient, leading to a decrease in the efficiency of the nitridation reaction of boron, which necessitates performing the reaction for a long time. Also, if the rate of reaction gas supplied to the chamber 330 exceeds 1000 sccm, the fast flow of the reaction gas may cause ablation of boron powder within the precursor, reducing the production yield of boron nitride nanotubes.

For example, if the reaction gas includes nitrogen (N2) and/or ammonia (NH3), the supply rate of nitrogen and/or ammonia may be from 10 sccm to 1000 sccm. As another example, if the reaction gas includes hydrogen (H2), the supply rate of hydrogen may be 10 sccm to 100 sccm.

Meanwhile, the chambers 330 of the reaction unit 300 may include an inlet 310 connected to the supply unit 200 on one side, and an outlet 320 connected to the discharge unit 400 on the other side. At this time, the gates may be installed both at the inlet 310 and the outlet 320, respectively, to separate the chambers 330 from the environment of the supply unit 200 and the discharge unit 400.

Additionally, the boron nitride nanotubes synthesis apparatus 1000 may further include a vacuum processing unit. The vacuum processing unit is connected to the chamber 330, and may control the vacuum level inside the chamber 330, and for this purpose, the vacuum processing unit may include a vacuum pump and a controller. The vacuum processing unit may be connected to the inlet 310 and/or the outlet 320.

Meanwhile, in the step of discharging S140 from the reaction unit 300 to the discharge unit 400, the nanomaterials (e.g., boron nitride nanotubes) synthesized during passing through the reaction unit 300 may be discharged to the discharge unit 400 through the outlet 320. At this time, the nanomaterials may freely fall through the outlet 320, and be stored in the discharge unit 400. Accordingly, a buffering member may be provided on the bottom surface of the discharge unit 400. By providing a buffering member on the bottom surface of the discharge unit 400, damage, breakage, and deformation of the synthesized precursors into nanomaterials falling freely from the chamber 330 to the discharge unit 400 may be effectively suppressed.

The synthesized precursors into nanomaterials may be stored in a storage unit 500 connected to the discharge unit 400. A large amount of nanomaterials may be stored in the storage unit 500. A discharge gate 410 is provided between the storage unit 500 and the discharge unit 400, allowing the nanomaterials stored in the discharge unit 400 to be transferred to the storage unit 500 when the discharge gate 410 is opened. At this time, a buffering member may be provided on the bottom surface of the storage unit 500. When all nanomaterials have been transferred to the storage unit 500, the discharge gate 410 provided between the storage unit 500 and the discharge unit 400 may be closed, and the storage unit 500 may be separated to collect the synthesized nanomaterials.

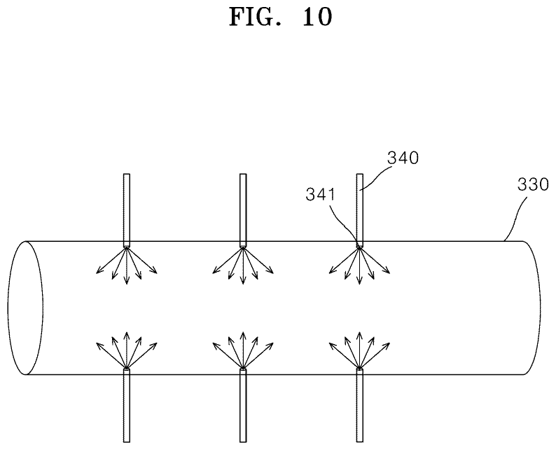

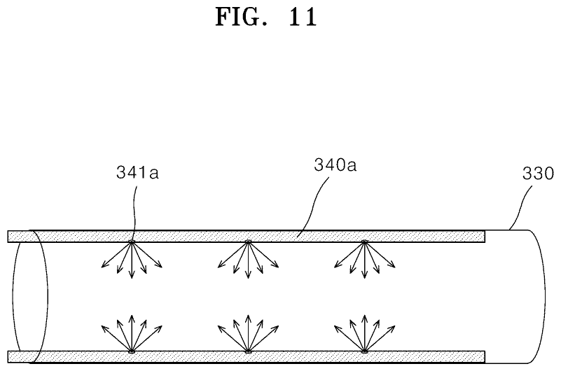

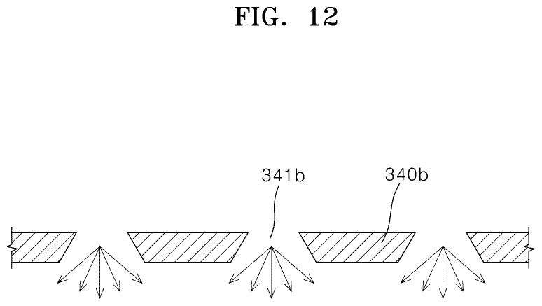

FIG. 10 is a schematic perspective view illustrating another example of the chamber and tubing of the reaction unit of FIG. 8, FIG. 11 is a schematic perspective view illustrating yet another example of the chamber and tubing of the reaction unit of FIG. 8, and FIG. 12 is a schematic perspective view illustrating still another example of the chamber and tubing of the reaction unit of FIG. 8.

Referring to FIGS. 10 to 12 in conjunction with FIG. 8, the reaction unit 300 according to embodiments of the present invention may include: the multiple tubular chambers 330 where precursors 10 react with the reaction gas to synthesize nanomaterials; the multiple heaters 350 spaced apart from and located on both sides of each chamber 330; and a temperature sensor 360 located in at least one chamber 330.

The reaction unit 300 may include a first region Z1, a second region Z2, and a third region Z3 having different average temperatures. At this time, the average temperature of the third region Z3 may be higher than the average temperature of the second region Z2, and the average temperature of the second region Z2 may be higher than the average temperature of the first region Z1.

Additionally, the reaction unit 300 may further include a fourth region Z4 and a fifth region Z5 having different average temperatures, both lower than the average temperature of the third region Z3. Specifically, the average temperature of the third region Z3 may be higher than the average temperature of the fourth region Z4, and the average temperature of the fourth region Z4 may be higher than the average temperature of the fifth region Z5.

Meanwhile, each of the chambers 330 may be connected to two or more tubes 340, 340a, 340b that supply the reaction gas. Additionally, each of the tubes 340, 340a, 340b may include the gas injection ports 341, 341a, 341b from which the reaction gas is injected. The gas injection ports 341, 341a, 341b may include openings to allow the reaction gas to be injected into the chamber 330.

Referring to FIG. 10, the tubes 340 may be arranged spaced apart from each other along the longitudinal direction of the chamber 330. At this time, each of the tubes 340 may vertically penetrate the chamber 330 from the top and bottom of the chamber 330 and extend into the chamber 330. Accordingly, each of the tubes 340 may directly inject the reaction gas into the chamber 330.

As such, by arranging the multiple tubes 340 at the top and bottom of the chamber 330 along its longitudinal direction, and directly injecting the reaction gas into the chamber 330, the concentration of the reaction gas reacting with the precursors 10 in the chamber 330 may be kept uniform, thereby improving the synthesis efficiency of nanomaterials.

Referring to FIG. 11, each of the tubes 340a) may be directly placed inside the chamber 330 at the top and bottom of the inner surfaces of the chamber 330 along the longitudinal direction of the chamber 330. At this time, each of the tubes 340a may be provided with the gas injection ports 341a spaced at a certain distance from each other. Accordingly, each of the tubes 340a may directly inject the reaction gas into the chamber 330.

As such, by arranging the multiple tubes 340a at the top and bottom of the inner surface of the chamber 330 along its longitudinal direction, and by arranging the gas injection ports 341a spaced apart from each other on each tubes 340a, and consequently directly injecting the reaction gas into the chamber 330, the concentration of the reaction gas reacting with the precursors 10 in the chamber 330 may be kept uniform, thereby improving the synthesis efficiency of nanomaterials.

Referring to FIG. 12, each of the multiple gas injection ports 341b included in the tubes 340b may include an inclined surface such that the area of the opening of the gas injection ports 341b is narrower for the outside the chamber 330 than the inside the chamber 330. As a result, when the reaction gas is injected into the chamber 330, vortexing caused by the expansion of the reaction gas may be prevented, and the deposition of the particles generated during the reaction may be prevented in the gas injection ports 341b, thus preventing the opening of the gas injection ports 341b from becoming blocked, which may improve the synthesis efficiency of nanomaterials.

Although the present invention has been described by limited embodiments and drawings, the present invention is not limited thereby, and it goes without saying that various modifications and variations can be made within the technical spirit of the present invention and the equivalent scope of the claims described below by those with ordinary skill in the art to which the present invention pertains.

1. A boron nitride nanotubes synthesis apparatus comprising:
a storage unit configured to accommodate precursor units, each containing multiple precursors and forming multiple rows;
a reaction unit configured to receive the precursor units accommodated in the storage unit and synthesize nanomaterials using the precursors; and
a supply unit connected to the storage unit and the reaction unit, and configured to receive the precursor units from the storage unit one row at a time and supply the precursor units to the reaction unit;
wherein the reaction unit comprises multiple tubular chambers that the precursors of the precursor units are simultaneously fed; and
wherein the reaction unit comprises at least one heater and a first region, a second region, and a third region having different average temperatures, and the average temperature of the third region is higher than the average temperatures of the first region and the second region.

2. The boron nitride nanotubes synthesis apparatus of claim 1, wherein the precursor is a precursor for the boron nitride nanotubes synthesis.

3. The boron nitride nanotubes synthesis apparatus of claim 1, wherein the supply unit comprises at least one pusher for feeding the precursor units into the reaction unit.

4. The boron nitride nanotubes synthesis apparatus of claim 3, wherein the pusher simultaneously pushes the precursors of the one row of precursor units.

5. The boron nitride nanotubes synthesis apparatus of claim 1, wherein the storage unit is vertically movable.

6. The boron nitride nanotubes synthesis apparatus of claim 5, wherein outer surface of the storage unit comprises a guide part for guiding the movement of the storage unit.

7. The boron nitride nanotubes synthesis apparatus of claim 1, wherein each of the chambers is connected to two or more tubes for supplying reaction gas.

8. The boron nitride nanotubes synthesis apparatus of claim 1, wherein the reaction unit further comprises a fourth region and a fifth region having different average temperatures, both lower than the average temperature of the third region.

9. A method for synthesizing boron nitride nanotubes comprising the steps of:
transferring precursor units, each containing multiple precursors and forming multiple rows, to a supply unit;
simultaneously feeding the precursors of a single row of the precursor units into a reaction unit by a pusher;
synthesizing nanomaterials by reacting the precursor units with reaction gas fed into the reaction unit; and
discharging the synthesized nanomaterials from the reaction unit to a discharge unit;
wherein the reaction unit comprises multiple tubular chambers that the precursors of the precursor units are simultaneously fed; and
wherein the reaction unit comprises at least one heater and a first region, a second region, and a third region having different average temperatures, and the average temperature of the third region is higher than the average temperature of the second region.

10. The method for synthesizing boron nitride nanotubes of claim 9, wherein a rate of the temperature changes over time in the reaction unit is 4° C./min to 9° C./min.

11. The method for synthesizing boron nitride nanotubes of claim 9, wherein each of the chambers is connected to two or more tubes for supplying the reaction gas.

12. The method for synthesizing boron nitride nanotubes of claim 9, wherein in the step of transferring to the supply unit, a storage unit moves towards the supply unit to transfer the precursor units to the supply unit.

13. The method for synthesizing boron nitride nanotubes of claim 12, wherein as all the precursor units accommodated in the storage unit have been supplied to the supply unit, the storage unit moves to the opposite direction of the supply unit.

14. The method for synthesizing boron nitride nanotubes of claim 9, wherein the nanomaterials are synthesized in the third region.

15. The method for synthesizing boron nitride nanotubes of claim 9, wherein the reaction unit further comprises a fourth region and a fifth region having different average temperatures, both lower than the average temperature of the third region.
